(19) United States
(12) Patent Application Publication
(10) Pub. No.: US 2005/0010479 A1
(43) Pub. Date: Jan. 13, 2005

(54) Method and apparatus for generating data to support fuel tax rebates

(76) Inventors: Sean D. Hannigan, Leduc (CA); Robert Douglas Bebb, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/697,381

(22) Filed: Oct. 30, 2003

(30) Foreign Application Priority Data
Jul. 7, 2003 (CA) 2,434,707

(51) Int. Cl. G06F 17/60

(52) U.S. Cl. 705/19; 705/30

(57) ABSTRACT

A method and apparatus for generating data to support fuel tax rebates. A first step involves providing at least one computing device containing geographic data regarding highways. A second step involves equipping a motor vehicle that consumes fuel with a positioning system for generating positioning data as to the latitude and longitude of the vehicle. A third step involves providing fuel consumption data and positioning data to the at least one computing device. By comparing the positioning data with the geographic data regarding highways, it can be determined when fuel is being consumed off-highway for which a tax fuel rebate can be claimed and an accurate record can be maintained of such off-highway use.

### FIELD OF THE INVENTION

The present invention relates to a fuel consumption tracking system and, in particular, a fuel consumption tracking system which provides the data necessary to apply for fuel tax rebates from taxing authorities.

### BACKGROUND OF THE INVENTION

Most State governments within the United States of America and Provincial governments within Canada collect a fuel tax on vehicular fuels. U.S. Pat. No. 5,928,291 (Jenkins et al 1999) entitled “Mileage and Fuel consumption determination for geo-cell based vehicle information management” discloses a system which integrates an on-board computer, a precise positioning system, and communication system to provide automated calculating and reporting of jurisdictional fuel taxes, road use taxes, vehicle registration fees and the like.

Many jurisdictions offer fuel tax rebates under certain circumstances. One of the most common qualifying criterion for such tax rebates occurs when a vehicle is not being operated on a public highway. U.S. Pat. No. 4,630,292 (Juricich et al 1986) entitled “Fuel Tax Rebate Recorder” discloses a system which records the total time a motor vehicle is running, the time that the motor is running while the vehicle is stationary, and the time the motor is running while the vehicle is moving. The premise behind the system is that a rebate of road taxes can be obtained for fuel used while the vehicle is stationary.

### SUMMARY OF THE INVENTION

What is required is an alternative method and apparatus for generating data to support fuel tax rebates.

According to one aspect of the present invention there is provided a method for generating data to support fuel tax rebates. A first step involves providing at least one computing device containing geographic data regarding highways. A second step involves equipping a motor vehicle that consumes fuel with a positioning system for generating positioning data as to the latitude and longitude of the vehicle. A third step involves providing fuel consumption data and positioning data to the at least one computing device. By comparing the positioning data with the geographic data regarding highways, it can be determined when fuel is being consumed off-highway for which a tax fuel rebate can be claimed and an accurate record can be maintained of such off-highway use.

Although beneficial results may be obtained through the use of the method described above, it is preferred that two computing devices be used including a stationary base computing device in which is stored geographic data and a mobile computing device positioned within the vehicle in which is stored fuel consumption data and positioning data. Means is provided for data transfer between the mobile computing device and the stationary base computing device.

According to another aspect of the present invention there is provided an apparatus for generating data to support fuel tax rebates. A stationary base computing device is provided containing geographic data regarding highways. A positioning system is provided for generating positioning data as to the latitude and longitude of a motor vehicle. Means are provided for collecting data on fuel consumption of the motor vehicle. A mobile computing device is positioned in the vehicle which is adapted to monitor fuel consumed during operation of the vehicle and collect positioning data from the positioning system. Means are provided for transferring data from the mobile computing device to the stationary base computing device. The stationary base computing device compares the positioning data with the geographic data regarding highways to determine when fuel is being consumed off-highway for which a tax fuel rebate can be claimed and maintains an accurate record of such off-highway use.

The key aspect of the above described method and apparatus are that an accurate record is kept of highway use as compared to off-highway use. This record is fully supported by geographical information system (GIS) data of highway location as compared to global positioning system (GPS) data regarding the position of the vehicle as fuel is being consumed. This provides a much more accurate indication of highway use and off-highway use, than merely data regarding whether the vehicle is moving or stationary during fuel consumption as provided by the system disclosed in the Juricich et al reference.

For vehicles that only operate within one jurisdiction, there is no need to maintain a record of geographical boundaries as taught by the Jenkins et al reference. However, for vehicles that operate in several jurisdictions even more beneficial results may be obtained when the computing device contains geographic data regarding the boundaries of taxing jurisdictions. This enables the processor to monitor fuel consumed during operation of the vehicle and, by comparing the positioning data with the geographic data regarding boundaries of taxing jurisdictions, determine a particular one of the taxing jurisdictions in which the fuel is being consumed.

There are several ways to determine what fuel has been consumed. A first method is to provide the vehicle with fuel flow sensors. A first fuel flow sensor can be positioned on a fuel feed line through which fuel passes from a fuel tank to a motor. A second fuel flow sensor can be positioned on a fuel return line through which unconsumed fuel passes from the motor back to the fuel tank. The difference between the fuel flow sensed by the first fuel flow sensor and the unconsumed fuel sensed by the second fuel flow sensor provides an accurate indication of fuel consumption. A second method is to couple the processor with an on-board diagnostics processor of the vehicle. Data received from the on-board diagnostics processor permits the processor to perform calculations of fuel consumption. A third method is to infer fuel consumption working from known parameters such as vehicle size, type and engine displacement and using data as to speed and elevation changes obtained from the global positioning system. Such a system could be calibrated over time to improve accuracy, based upon a comparison with fuel purchase receipts.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an exploded perspective view of a motor vehicle equipped with an apparatus for generating data to support fuel tax rebates constructed in accordance with the teachings of the present invention.

FIG. 2 is a hardware context diagram of the apparatus illustrated in FIG. 1.

FIG. 3 is a graphical representation of a highway system represented as a polyline geometry.

### DETAILED DESCRIPTION OF THE PREFERRED EMBODIMENT

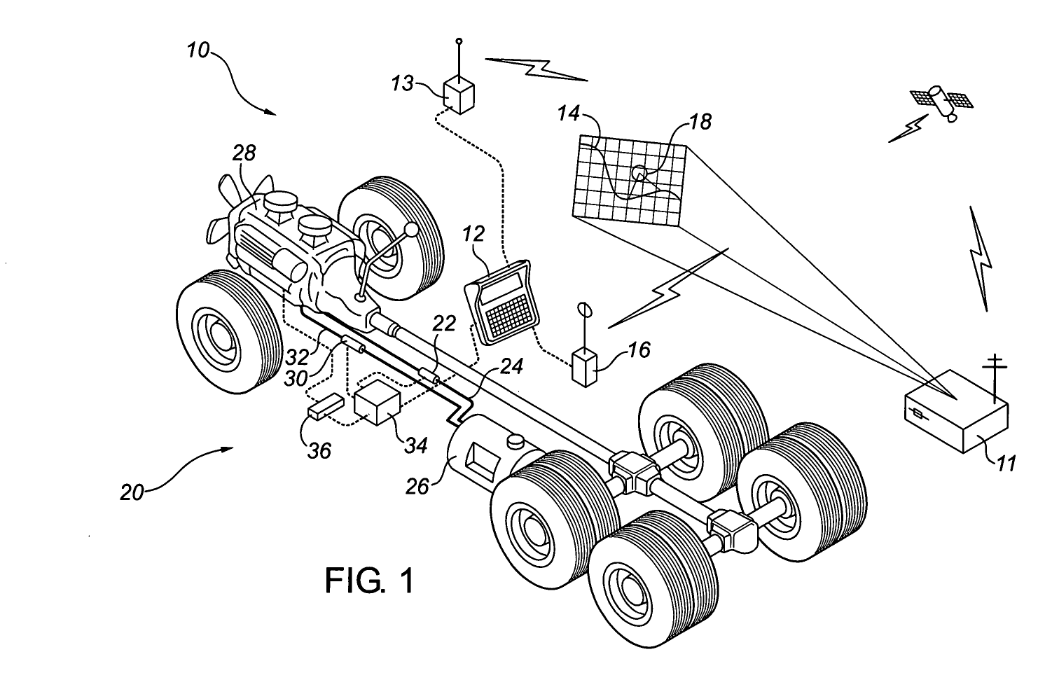

The preferred embodiment, an apparatus for generating data to support fuel tax rebates, generally identified by reference numeral 10, will now be described with reference to FIGS. 1 through 3.

Structure and Relationship of Parts:

Referring to FIG. 1, there is provided an apparatus 10 which includes a stationary base computing device 11 and a mobile computing device 12. The invention could be put into effect with a single mobile computing device, however, the use of two computing devices is preferred as will hereinafter be further described. Mobile computing device 12 communicates with stationary base computing device 11 via a data link 13. Stationary base computing device 11 contains geographic data regarding highways 14. A positioning system 16 is linked to mobile computing device 12 and generates positioning data 18 as to the latitude and longitude of a motor vehicle 20. In the illustrated embodiment, vehicle 20 is adapted with a first fuel flow sensor 22, positioned on a fuel feed line 24 which flows fuel from fuel tank 26 to motor 28, and a second fuel flow sensor 30, positioned on a fuel return line 32 which flows fuel from motor 28 back to fuel tank 26. A processor 34 which is linked to and forms part of mobile computing device 12, monitors fuel consumption. Processor 34 is connected to first fuel flow sensor 22 and second fuel flow sensor 30. In the illustrated embodiment, processor 34 is also coupled to a diagnostic processor 36 which monitors the functions of motor 28.

Operation:

The use and operation of apparatus for generating data to support fuel tax rebates 10 will now be described with Reference to FIGS. 1 through 3. A first step involves providing stationary base computing device 11 containing geographic data regarding highways 14. It will be appreciated that stationary base computing device 11 may also provide data regarding the boundaries of taxing jurisdictions. A second step involves equipping a motor vehicle 20 that consumes fuel with a positioning system 16 that generates positioning data 18 as to the latitude and longitude of vehicle 20. A third step involves providing motor vehicle 20 with a mobile computing device 12 which includes a processor 34 which monitors fuel consumed during operation of vehicle 20. In the illustrated embodiment this is accomplished by providing a first fuel flow sensor 22, positioned on a fuel feed line 24, and a second fuel flow sensor 30, positioned on a fuel return line 32. During operation of motor vehicle 20, positioning system 16 gathers positioning data 18 and provides it to mobile computing device 12. At periodic intervals mobile computing device 12 communicates with stationary base computing device 11 through data link 13, transferring geographic positioning data and fuel consumption data. Stationary base computing device 11 compares positioning data 18 with it own geographic data regarding highways 14 and, in turn, determines whether vehicle 20 is off-highway. First fuel flow sensor 22 and second fuel flow sensor 30 provide fuel flow data to processor 34. The difference between two flows, is indicative of the quantity of fuel is being consumed. If vehicle 20 is off-highway at that moment, this information allows stationary base computing device 11 to determine that fuel is being consumed while vehicle 20 is off-highway. Further, stationary base computing device 11 will keep a record of off-highway use which will later support a claim for a tax fuel rebate. If stationary base computing device 12 provides data on taxing jurisdictions, it will provide information that is adjusted for operation in multiple jurisdictions. There are a number of alternative ways of establishing boundary information on taxing jurisdictions. One way is by using a mapping concept. Another way is to break down the network of highways into a plurality of highway segments, with each highway segment being electronically tagged as belonging to a particular taxing jurisdiction. This tagging may also be done with roads that are non-taxable. For example, some forestry roads in the Province of British Columbia are considered “off highway” and non-taxable even though they appear on public maps. This is due to peculiarities in relation to road maintenance responsibilities. Maintenance of such non-taxable forestry roads falls upon private industry and not upon the Province of British Columbia.

Advantages are obtained by coupling diagnostic processor 36 of the vehicle to processor 34. This enables a wider range of reporting to be provided using supplementary data from diagnostic processor 36 relating to such things as fuel consumption, load and maintenance.

While the use of fuel flow sensors is preferred, it is not essential to operation. It is possible to calculate fuel consumption from data provided by diagnostic processor 36. It is also possible to infer fuel consumption working from known parameters such as vehicle size, type and engine displacement and using data as to speed and elevation changes obtained from the global positioning system. Such a system could be calibrated over time to improve accuracy, based upon a comparison with fuel purchase receipts.

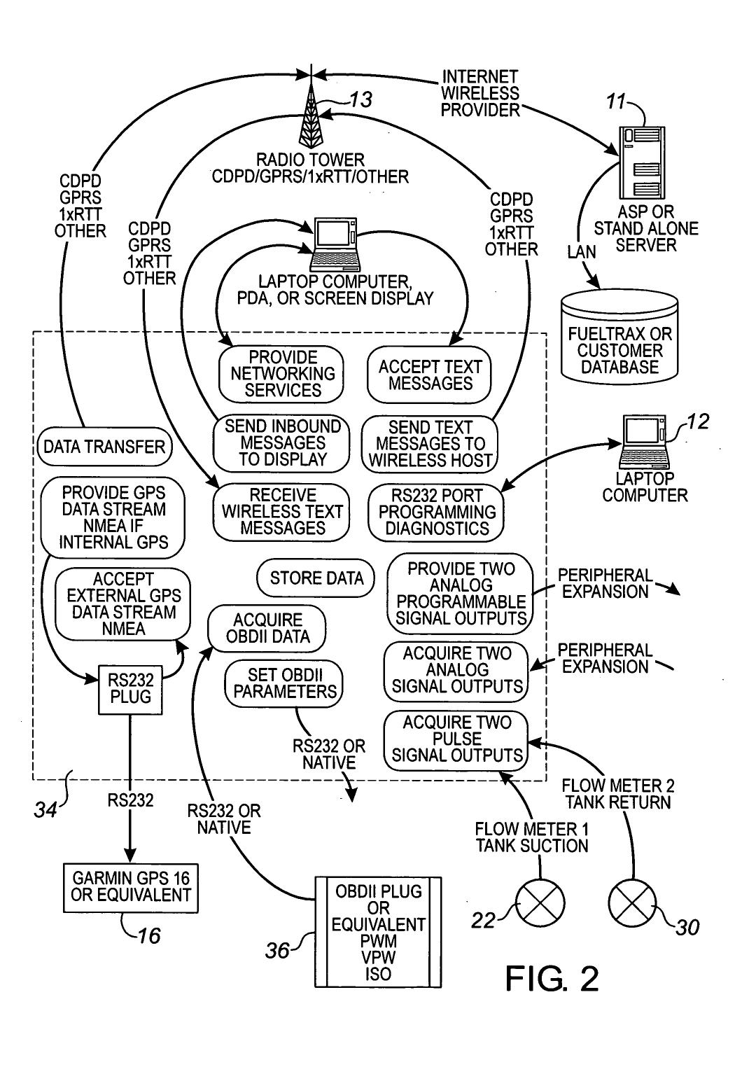

FIG. 2 illustrates the relationship between the various components which make up the preferred version of the system.

Further Detail On System Operation:

1. Data Acquisition

a. Positional

While several methods are available for the task of position finding, the Global Positioning System (“GPS”) is likely to be the only method employed by the system. Several vendors are available to supply the GPS hardware as either an electronic circuit board or a microchip. The standard National Marine Electronics (“NMEA”) data stream is provided by all GPS hardware and will be parsed and utilized by the system.

a. Engine Diagnostic

From 1996, certain engine operating data is mandated by the US Federal government to be available for the purpose of facilitating pollution control efforts. This is sometimes referred to by the acronym On Board Diagnostics (“OBD”). A number of standards exist and there are differences to be found between large transport trucks and smaller passenger vehicles but data-bus translators are commercially available to provide access to the data via a standard RS232 interface. Some of this data such as SPEED, RPM-and Percentage of Load are likely to be useful for the purpose of inferring fuel consumption rates and will be used in the standard service configuration.

It is contemplated that a more complete set of diagnostic data will be made available, as an optional package, for those clients with an interest in maintenance issues.

b. Flowmeter

In certain cases it may be desirable to directly measure the rate of fuel consumption by using of inline flowmeters. Two flowmeters are generally required for this purpose; the first measuring fuel flow FROM the tank and the second measuring fuel returned TO the tank. Fuel consumption is calculated as the difference between the two rates. Two pulse counting circuits will be included as an interface to the flowmeters. Flowmeter calibration corrections will likely be applied server-side rather than at the vehicle.

c. Other

Other remote monitoring and control functions are foreseen and will be provided for. Some examples are cargo temperature, door ajar indicator and remote engine disabling.

2. Data Remote Storage

Data will necessarily be stored within the remote unit because a mechanism for data transfer will not always be immediately available. When a vehicle returns to an area or location where contact can be re-established after having been out of contact for a period of time, the accumulated data will be transmitted in batch form.

It is contemplated that the most recent 30 days of data will always be stored and available on the remote unit.

3. Data Transfer

a. Methods of Data Transfer

In the ideal embodiment data will be transferred via TCP/IP-based cellular networks. The current art employs a transfer protocol with the acronym Cellular Digital Packet Data (“CDPD”). CDPD is a widely accepted standard offered by major cellular network providers but is nearing the end of its service life, primarily due to its relatively low transfer rate of 14K baud.

Two newer technologies are emerging to replace CDPD. These are Generalized Packet Radio Service (“GPRS”) and 1xRTT. GPRS is based on GSM technology while 1xRTT is based upon TDMA/CDMA technology. GSM predominates in Europe while TDMA/CDMA has the best coverage available in North America.

The system will initially use the CDMA—1xRTT standard.

In some instances, customers may not wish to bear the added expense of the embedded cellular modem card and the cellular service contract required for real-time data transfer. In these instances a hard-wired method of data transfer will be provided via an RS-232 port or LAN connection. Satellite is another possibility for data transfer.

b. Standard Dataset

The standard transmission dataset will include time, date, GPS positional data and that portion of the OBD dataset that is useful in the calculation of the amount of fuel consumed. Where available, fuel line flowmeter data and tank level data will be included.

c. Engine Diagnostic Dataset

A more complete dataset of engine diagnostic information will be provided on an optional basis for an additional charge.

d. Text Messaging

Text messaging will be an optional service that may take one of 3 forms:
i. A small dash mounted optical display screen connected via an RS-232 port, or other;
ii. A personal digital assistant (“PDA”) device connected through an RS-232 port, or other;
iii. A laptop computer running software that will permit the sending and receiving of text messages, similar to live-chat software in common usage over the internet.

e. Voice Communications

Most embedded cellular communication boards under consideration for the system also have the capacity to support voice communications. The transport mechanism may be Voice-Over-Packet, Voice-Over-IP, or a more conventional transport mode. While it is not clear how this capacity will be used by the system at this point in time, we may wish to include voice communication as an optional service just because we can.

f. Networking Services

Many transportation companies have preferred enterprise software that may include dispatching capabilities. Providing a full mobile networking connection would be of benefit. It would permit client companies to remotely run the enterprise software of their choosing while at the same time removing the competitive need for a custom-dispatching solution.

A single Dynamic Host Configuration Protocol (“DHCP”) IP address would be adequate for this purpose. Client enterprise software could then be run via a 3^{rd} party remote software such as Citrix Server or MS Terminal Server.

4. Data Manipulation

a. On-Road/Off-Road Determination

GIS data differs from conventional data in that it is described by geometric shapes such as polylines and polygons, in addition to the more familiar point values that underpin conventional data manipulation. Our task is to compare a GPS point value to a network of highways (polylines) to determine if, within a varying margin of error, the GPS point does or does not fall on a highway.

i. Perpendicular Distance from Polyline Geometries

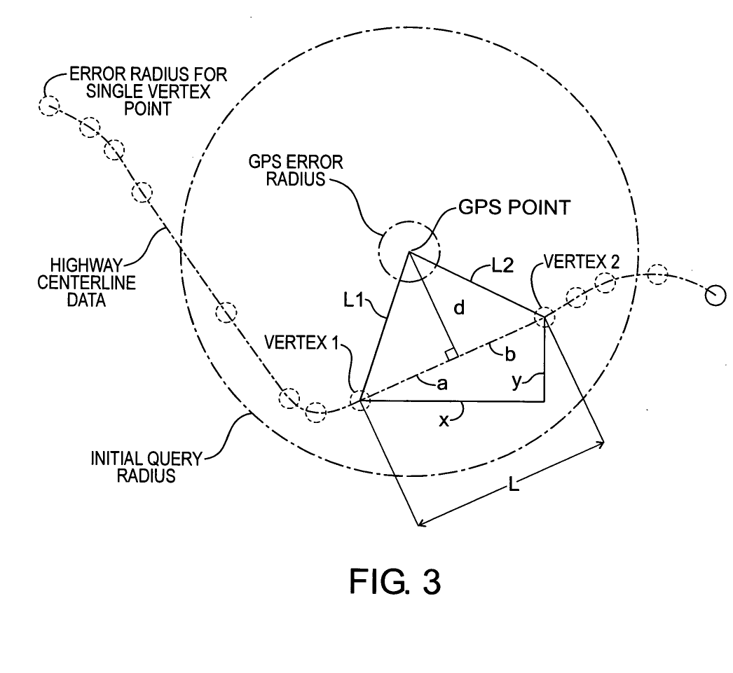

Referring to FIG. 3, highway systems are commonly represented and stored as polylines geometries. A polyline is typically composed of a number of points or vertices that are connected by either straight-line segments or arc-line segments. Straight-line segments seem to be the more common method.

By deconstructing the highway polylines into their constituent vertices, and then storing the latitude and longitude or other XY representation such as Universal Transverse Mercator (“UTM”) of these vertices as individual database entries, the highway geometries can be handled with standard Structured Query Language (“SQL”) queries.

The procedure is to query the database for all vertices within a fixed distance of the GPS point under consideration. The result set is then placed in order of closest proximity to the GPS point, using the following formulation:
Xp=longitude of GPS point;
Yp=latitude of GPS point;
Xi=longitude of point (i) from result set;
Yi=latitude of point (i) from result set;
   Distance=Square Root((Xp−Xi)″+(Yp−Yi)″)

If the query result set is empty then the GPS location is deemed to be off road.

If the result set contains a single data vertex then calculation of the distance to the highway is trivial matter.

If the query returns two or more vertices then the perpendicular distance to the highway, shown as dimension “d” in FIG. 3 is calculated from the first two (closest) vertices in the ordered query result set. Vertex 1 and Vertex 2 are the closest of 2 of the 7 vertices falling within the initial query radius and are used in the following formulation:
b=(L″+L2″−L1″)/2L
d=Square Root(L2″−b″)

After making an allowance for the variable uncertainty in each GPS Point, determined by the number of satellites used for the GPS fix and other factors, an on-road/off-road determination can be made based upon a predetermined threshold value. This threshold value may need to be agreed upon by all parties, including the relevant tax authority.

ii. Alternate Methods of Determination

Several mapping software packages have a built in proprietary query languages that would permit a user to make a determination of an off-road condition. The drawback here is that these proprietary query languages are generally built for single users and are not generally amenable to automation on a server.

Oracle 8i and Oracle 9i offer a Spatial Data Extension to their most expensive Enterprise Editions that could be used to make a determination of an off-road condition. This is also suitable for use as an automated server process through the use of extensions to the SQL query language.

b. Fuel Consumption Calculations

i. With Flowmeters

In some instances it may be desirable to physically insert two calibrated flowmeters into the vehicle fuel system. One flowmeter will be placed on the fuel feed-line and the other on the tank return-line; fuel consumption being calculated as the difference between these two measured amounts.

Flowmeters typically output pulses that can be counted and recorded by the system. It is presently contemplated that any required signal linearizing algorithms, calibrations and totalizing computations will be applied on the server rather than at the remote unit.

ii. Without Flowmeters

An algorithm will be developed to predict fuel consumption in the absence of flowmeter data. Parameters input to this algorithm are likely to include speed, RPM, percentage of engine load, vehicle type, engine displacement, OBD engine efficiency data, and change in altitude between successive GPS positioning. The algorithm will be amended and improved over time and can be calibrated against a vehicle that has flowmeters installed.

5. Data Presentation and Reporting

a. Activity Reports

Summary information may be provided for each vehicle, detailing hours of operation, distance traveled, and other requested operating parameters. Standard and customized reporting will be provided.

b. Real-Time Mapping

It is contemplated that customers will be provided a method to retrieve up-to-the-minute locations and historical maps of the travels of their vehicles.

c. Fuel Tax Rebate Applications

It is contemplated that audit trail data will be provided in support of fuel tax rebate applications. Every effort will be made to streamline this application process for each tax jurisdiction where the system operates. It is likely that the required forms will be automatically prepared and provided to customers.

d. Engine Performance Reports

Reporting may be provided on engine performance data where such data can be obtained from the OBD data port.

e. Safety Reports

Reporting may be provided detailing excessive speeds, excessive RPM, hard braking and deceleration events for vehicles.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method for generating data to support fuel tax rebates, comprising the steps of:
providing at least one computing device containing geographic data regarding highways;
equipping a motor vehicle that consumes fuel with a positioning system for generating positioning data as to the latitude and longitude of the vehicle;
providing fuel consumption data and positioning data to the at least one computing device which, by comparing the positioning data with the geographic data regarding highways, determines when fuel is being consumed off-highway for which a tax fuel rebate can be claimed and maintains an accurate record of such off-highway use.

2. The method as defined in claim 1, there being two computing devices a stationary base computing device in which is stored geographic data and a mobile computing device positioned within the vehicle in which is stored fuel consumption data and positioning data, means being provided for data transfer between the mobile computing device and the stationary base computing device.

3. The method as defined in claim 1, the at least one computing device further containing geographic data regarding the boundaries of taxing jurisdictions and, by comparing the positioning data with the geographic data regarding boundaries of taxing jurisdictions, determines a particular one of the taxing jurisdictions in which the fuel is being consumed.

4. The method as defined in claim 1, the vehicle being provided with fuel flow sensors including a first fuel flow sensor on a fuel feed line through which fuel passes from a fuel tank to a motor and a second fuel flow sensor on a fuel return line through which unconsumed fuel passes from the motor back to the fuel tank.

5. The method as defined in claim 1, the at least one computing device being coupled with and receiving data from an on-board diagnostics processor of the vehicle, which permits calculation to be performed as to fuel consumption.

6. An apparatus for generating data to support fuel tax rebates, comprising in combination:
a stationary base computing device containing geographic data regarding highways;
a positioning system for generating positioning data as to the latitude and longitude of a motor vehicle;
means for collecting data on fuel consumption of the motor vehicle;
a mobile computing device positioned in the vehicle and adapted to monitor fuel consumed during operation of the vehicle and positioning data;
means for transferring data from the mobile computing device to the stationary base computing device, the stationary base computing device comparing the positioning data with the geographic data regarding highways to determine when fuel is being consumed off-highway for which a tax fuel rebate can be claimed and maintain an accurate record of such off-highway use.

7. The apparatus as defined in claim 6, wherein the stationary base computing device further contains geographic data regarding the boundaries of taxing jurisdictions and, by comparing the positioning data with the geographic data regarding boundaries of taxing jurisdictions, determines a particular one of the taxing jurisdictions in which the fuel is being consumed.

8. The apparatus as defined in claim 6, in combination with fuel flow sensors including a first fuel flow sensor on a fuel feed line through which fuel passes from a fuel tank to a motor and a second fuel flow sensor on a fuel return line through which unconsumed fuel passes from the motor back to the fuel tank.

9. The apparatus as defined in claim 6, in combination with an on-board diagnostics processor of the vehicle, the mobile computing device being coupled with and receiving data from an on-board diagnostics processor of the vehicle, which permits the mobile computing device to perform calculations of fuel consumption.
